(19) United States
(12) Patent Application Publication
(10) Pub. No.: US 2024/0392074 A1
(43) Pub. Date: Nov. 28, 2024

(54) INSULATED WIRE, WIRE HARNESS, AND PRODUCTION METHOD FOR INSULATED WIRE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP); KYUSHU UNIVERSITY, NATIONAL UNIVERSITY CORPORATION, Fukuoka-shi, Fukuoka (JP)

(72) Inventors: Masashi SATO, Yokkaichi-shi (JP); Takehiro HOSOKAWA, Yokkaichi-shi (JP); Tatsuya SHIMADA, Yokkaichi-shi (JP); Makoto MIZOGUCHI, Fukuoka-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP); KYUSHU UNIVERSITY, NATIONAL UNIVERSITY CORPORATION, Fukuoka-shi, Fukuoka (JP)

(21) Appl. No.: 18/691,188

(22) PCT Filed: Sep. 8, 2022
(86) PCT No.: PCT/JP2022/033687

§ 371 Date: Mar. 12, 2024

(30) Foreign Application Priority Data
Sep. 28, 2021 (JP) 2021-157745

(51) Int. Cl. C08G 77/398; C08K 3/36; H01B 3/46; H01B 7/00; H01B 13/06

(52) U.S. Cl. CPC C08G 77/398; C08K 3/36; H01B 3/46; C08K 2201/005; H01B 7/0045; H01B 13/06

(57) ABSTRACT

An insulated wire includes a wire conductor and an insulation covering that is made of a crosslinked polymer material and covers the outer periphery of the wire conductor, the crosslinked polymer material includes a metal ion and a silicone resin having a side chain which includes a substituent group capable of forming an ionic bond with the metal ion, and the silicone resin forms a crosslinked product through the ionic bond between the substituent group and the metal ion. A crosslinkable polymer composition including a metal compound from which the metal ion is released by heat and the silicone resin is disposed on an outer periphery of the wire conductor, and then the crosslinked product is formed from the crosslinkable polymer composition by heating to produce the insulation covering made of the crosslinked polymer material, and thus the insulated wire is produced.

### TECHNICAL FIELD

The present disclosure relates to an insulated wire, a wire harness, and a production method for insulated wire.

### BACKGROUND ART

In insulated wires, a silicone resin is used in some cases as an insulation covering that covers a wire conductor. The silicone resin is often used by crosslinking a polymer chain to provide excellent properties such as heat resistance and flexibility. For example, PTL1 listed below discloses an insulated wire with excellent properties such as heat resistance that has an insulation covering made of a material comprising a crosslinked silicone resin. Here, the silicone resin is crosslinked using a crosslinking agent such as an organic peroxide. It is important that the insulation covering has high heat resistance, especially for the insulated wire that is disposed in an environment that is likely to reach a high temperature, such as inside automobiles.

### CITATION LIST

### Patent Literature

PTL1: JP 2014-65777 A
PTL2: WO 2011/074620
PTL3: JP H06-41436 A
PTL4: JP 2011-256253 A
PTL5: JP H07-11139 A

### SUMMARY OF INVENTION

### Technical Problem

As described above, by forming the insulation covering using a material comprising a crosslinked silicone resin, it is possible to satisfy the properties such as heat resistance and flexibility that are desired in insulated wires for use in automobiles and other applications. However, conventionally, a general silicone resin crosslinked with an organic compound such as an organic peroxide does not have very high oil resistance and tend to swell when coming into contact with oils such as oil and gasoline. It is desired that the insulated wire used in locations where contact with oils such as oil and gasoline is expected, such as inside automobiles, has high oil resistance as well as heat resistance.

In view of the above, it is an object of the present invention to provide an insulated wire made of a material comprising the silicone resin and provided with an insulation covering having high oil resistance, a wire harness including such an insulated wire, and a production method for such an insulated wire.

### Solution to Problem

An insulated wire according to the present disclosure is an insulated wire including: a wire conductor; and an insulation covering comprising a crosslinked polymer material and covering an outer periphery of the wire conductor, in which the crosslinked polymer material comprises a metal ion and a silicone resin comprising a side chain which comprises a substituent group capable of forming an ionic bond with the metal ion, and the silicone resin forms a crosslinked product through the ionic bond between the substituent group and the metal ion.

A wire harness according to the present disclosure comprises the insulated wire.

A production method for insulated wire according to the present disclosure includes: disposing a crosslinkable polymer composition comprising a metal compound from which the metal ion is released by heat and the silicone resin on an outer periphery of the wire conductor, and then producing the insulation covering comprising the crosslinked polymer material by forming the crosslinked product from the crosslinkable polymer composition by heating.

### Advantageous Effects of Invention

An insulated wire, a wire harness, and a production method for insulated wire according to the present disclosure are an insulated wire made of a material comprising a silicone resin and provided with an insulation covering having high oil resistance, a wire harness including such an insulated wire, and a method by which such an insulated wire is produced.

### BRIEF DESCRIPTION OF DRAWINGS

FIG. 1 is a perspective view showing a structure of an insulated wire according to an embodiment of the present disclosure.

FIG. 2 is a side view showing a structure of a wire harness according to an embodiment of the present disclosure.

### DESCRIPTION OF EMBODIMENTS

### Description of Embodiments of the Present Disclosure

First, embodiments of the present disclosure will be listed and described.

An insulated wire according to the present disclosure is an insulated wire including: a wire conductor; and an insulation covering comprising a crosslinked polymer material and covering an outer periphery of the wire conductor, in which the crosslinked polymer material comprises a metal ion and a silicone resin comprising a side chain which comprises a substituent group capable of forming an ionic bond with the metal ion, and the silicone resin forms a crosslinked product through the ionic bond between the substituent group and the metal ion.

In the insulated wire according to the present disclosure, the insulation covering is made of a crosslinked polymer material comprising a crosslinked silicone resin. Conventionally, in a general crosslinked silicone resin, a polymer chain of the silicone resin is crosslinked with a crosslinking agent composed of an organic substance such as an organic peroxide, and therefore the crosslinked silicone resin has a high affinity with oil and an oil component is likely to be incorporated into a network of the crosslinked product. On the other hand, in the insulated wire according to the present embodiment, the silicone resin forming the insulation covering comprises the side chain which comprises the substituent group capable of forming the ionic bond with the metal ion, and the silicone resin is crosslinked by the ionic bond between this substituent group and the metal ion. Accordingly, a crosslinking site becomes inorganic and has low affinity with oil. As a result, an oil component is less likely to be incorporated into the network of the crosslinked product, and the insulation covering exhibits high oil resistance. This insulation covering made of the crosslinked polymer material can be easily produced by disposing a composition comprising the silicone resin and a metal compound that releases the metal ion when heated on the outer periphery of the wire conductor through extrusion molding or the like, causing the metal ion to be released by heating, and forming the ionic bond between the silicone resin and the substituent group of the silicone resin to form the crosslinked product.

Here, it is preferable that the crosslinked polymer material comprises polar particles in addition to the crosslinked product. By adding the polar particles to a non-crosslinked silicone resin, the particles function as a molding aid. As a result, even if the non-crosslinked silicone resin has a low viscosity, the viscosity can be increased or thixotropy can be imparted by adding particles, making it easier to perform an operation of disposing the silicone resin on the outer periphery of the wire conductor by extrusion molding or the like.

In this case, it is preferable that the particles comprise at least one selected from the group consisting of silica, metal oxide, clay mineral, cellulose, fluororesin, and carbon. These particles exhibit high functionality as a molding aid.

In particular, it is preferable that the particles are fumed silica particles. Fumed silica is highly effective in improving the viscosity of a composition comprising the silicone resin as a molding aid.

It is preferable that the particles have an average particle size of 5 nm or larger and 100 nm or smaller. In this case, the particles tend to give the composition comprising the silicone resin a viscosity suitable for molding onto the outer periphery of the wire conductor through extrusion molding or the like.

It is preferable that the crosslinked polymer material comprises 1 part by mass or more and 100 parts by mass or less of the particles with respect to 100 parts by mass of the silicone resin. As a result, the particles are highly effective in improving the viscosity of the composition, and in the crosslinked polymer material obtained through crosslinking of the silicone resin, the material properties are less likely to be affected by including a large amount of particles.

It is preferable that the silicone resin has a flow-starting temperature of 150° C. or lower. In this case, even if the silicone resin is not heated to a high temperature, the silicone resin can be kneaded together with a metal compound or the like serving as a metal ion source to achieve a state in which the silicone resin is disposable on the outer periphery of the wire conductor through extrusion molding or the like.

It is preferable that the substituent group included in the silicone resin is an anionic group generated from at least one selected from the group consisting of carboxylic acid group, acid anhydride group, and phosphoric acid group. These substituent groups tend to form the ionic bond with the metal ion. Also, since the substituent group is an acidic group with relatively low polarity, it is difficult to cause phase separation with respect to a main chain and the side chain of the silicone resin, and it is possible to form a crosslinked structure with high spatial uniformity.

It is preferable that in the silicone resin, the substituent group is bonded to the main chain via an alkyl group or an alkylene group having one or more carbon atoms. This reduces the influence of the main chain on the formation of the crosslinked product, making it easier to form a crosslinked structure sufficiently and uniformly.

It is preferable that the main chain of the silicone resin does not comprise a moiety capable of forming the ionic bond with the metal ion. This stops the substituent group in the side chain from being prevented from forming the ionic bond with the metal ion due to competition with a moiety in the main chain that can form the ionic bond. The substituent group in the main chain is not likely to form a stable crosslinked structure with the metal ion.

It is preferable that the main chain of the silicone resin is an organopolysiloxane chain. In this case, the main chain is not likely to affect crosslinking in the side chain of the silicone resin.

It is preferable that the metal ion can be released by heat as a metal ion capable of forming a metal complex with a β-diketonato ligand or alkoxide ligand. The β-diketonato ligand and alkoxy ligand have an excellent effect of stabilizing the metal ion. Accordingly, before the silicone resin is crosslinked, the metal complex can be stably maintained in a state in which the metal ion is not released, and unintended progression of crosslinking can be suppressed.

In this case, it is preferable that the metal ion can be released as a metal ion from the metal complex due to heating at 50° C. or higher and 300° C. or lower. In this case, in a composition comprising the silicone resin and the metal complex, the metal complex can be stably maintained in a state where the metal ion is not released before the silicone resin is crosslinked, and unintended progression of crosslinking can be suppressed. Meanwhile, when intentionally crosslinking a silicone resin, the metal ion can be released and the silicone resin can be crosslinked without heating to a very high temperature.

It is preferable that the metal ion is an ion of at least one selected from the group consisting of alkaline earth metals, aluminum, zinc, titanium, and zirconium. Each of the metal ions easily forms a stable crosslinked structure between the polymer chain of the silicone resin, and thus is suitable as a metal for forming the crosslinked product.

It is preferable that the metal ion is an ion of at least one selected from the group consisting of aluminum and zirconium. Each of these metal ions tends to form a particularly stable crosslinked structure with the substituent group of the silicone resin. Also, at a relatively low temperature before crosslinking, each metal ion is likely to be stably maintained in the state of a metal compound that is not released as the metal ion.

It is preferable that the crosslinked polymer material comprises 0.03 parts by mass or more and 10 parts by mass or less of the metal ion with respect to 100 parts by mass of the silicone resin. In this case, due to including a sufficient amount of the metal ion, the crosslinking density becomes high, and the effect of improving the properties by crosslinking the silicone resin, such as improving heat resistance, improves. Meanwhile, it is easy to avoid the influence of a large amount of metal components being included in the material before and after crosslinking.

It is preferable that the crosslinked polymer material does not comprise a component in which the silicone resin is crosslinked without via the ionic bond between the substituent group and the metal ion, except for an unavoidable component. In this case, in the crosslinked polymer material, the effect of improving oil resistance can be significantly obtained by forming a crosslinked location between the polymer chains of the silicone resin through the ionic bond with the metal ion.

A wire harness according to the present disclosure comprises the insulated wire. The insulation covering of the insulated wire included in the wire harness has high oil resistance due to being made of the crosslinked polymer material including the crosslinked product in which the silicone resin including the side chain comprising the substituent group capable of forming the ionic bond with the metal ion is crosslinked by the ionic bond with the substituent group and the metal ion. For this reason, in the wire harness as well, the high oil resistance can be used as a property of the wire harness.

In a production method for insulated wire according to the present disclosure, the crosslinkable polymer composition comprising the metal compound from which the metal ion can be released by heat and the silicone resin are disposed on the outer periphery of the wire conductor, then the crosslinked product is manufactured from the crosslinkable polymer composition by heating to produce the insulation covering made of the crosslinked polymer material, and the insulated wire is produced. In this production method, the silicone resin comprising the side chain which comprises the substituent group capable of forming the ionic bond with the metal ion is crosslinked via the ionic bond with the metal ion, and therefore the crosslinked location takes on inorganic properties and does not exhibit a high affinity for oil, making it possible to form the insulation covering with high oil resistance. Furthermore, in this production method, the metal ion for crosslinking is supplied by being released from the metal compound by heat, and therefore it is possible to easily prepare the crosslinkable polymer composition in an uncrosslinked state, dispose the crosslinkable polymer composition on the outer periphery of the wire conductor, and perform a series of steps for forming the crosslinked product.

### Details of Embodiments of the Present Disclosure

An insulated wire, a wire harness, and a production method for insulated wire according to an embodiment of the present disclosure will be described below with reference to the drawings. Note that the present disclosure is not limited to these embodiments.

### <Overview of Insulated Wire and Wire Harness>

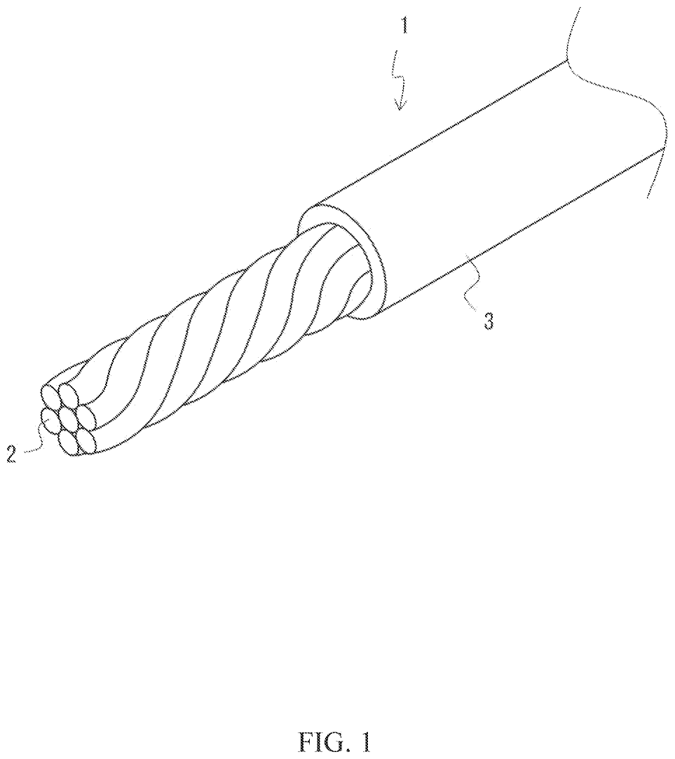

FIG. 1 shows the structure of an insulated wire 1 according to an embodiment of the present disclosure. The insulated wire 1 comprises a wire conductor 2 and an insulation covering 3 that covers the outer periphery of the wire conductor 2. The insulation covering 3 is made of a crosslinked polymer material that will be described later.

The wire conductor 2 of the insulated wire 1 is not particularly limited in its conductor diameter, material, and the like, and can be appropriately selected according to the application and the like of the insulated wire 1. Examples of the material composing the wire conductor 2 include a metal material such as copper, copper alloy, aluminum, and aluminum alloy. The wire conductor 2, although allowed to be made in the form of a single wire, is preferably made in the form of a twisted wire obtained by twisting a plurality of elemental wires twisted together from the viewpoint of ensuring flexibility and the like.

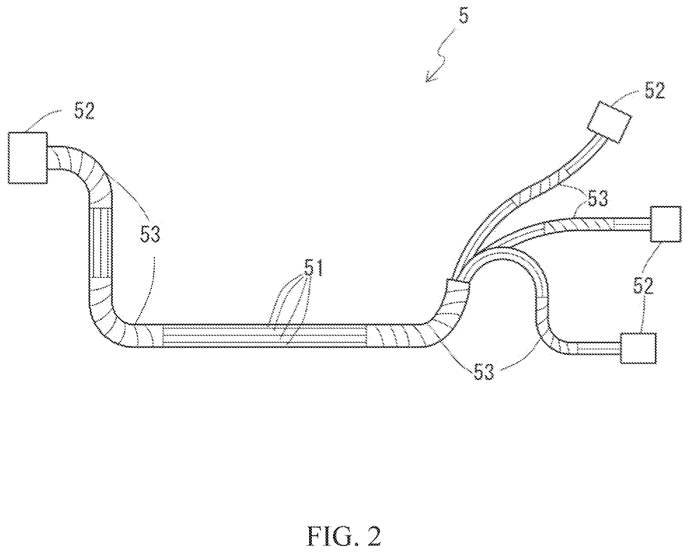

The wire harness according to the embodiment of the present disclosure is not particularly limited in its specific configuration as long as it includes the insulated wire 1 according to the embodiment of the present disclosure, but an exemplary structure of a wire harness 5 is shown in FIG. 2. As shown in FIG. 2, the wire harness 5 is provided with a connector 52 including a connection terminal (not shown), at the terminal end portions of an insulated wire 51. In the wire harness 5, a plurality of insulated wires 51 may also be bundled together, and in this case, a tape 53 may be used as an outer cover material for bundling the insulated wires 51. At least one, and preferably all, of the insulated wires 51 composing the wire harness 5 are composed of the insulated wire 1 according to the embodiment of the present disclosure.

Although the application of the insulated wire 1 and the wire harness 5 according to the embodiment of the present disclosure is not particularly limited, it is preferable that the insulated wire 1 and the wire harness 5 are used inside an automobile. As will be described later, the crosslinked polymer material composing the insulation covering 3 of the insulated wire 1 according to the present embodiment comprises the crosslinked product obtained by crosslinking a silicone resin with a metal ion, and has excellent heat resistance, flexibility, and oil resistance. Inside an automobile, there are many locations that reach high temperatures, and contact with gasoline and oil is also envisioned, but by disposing the insulated wire 1 and the wire harness 5 according to this embodiment in such an environment, it is possible to effectively use the properties of the crosslinked polymer material that comprises the insulation covering 3.

### <Constituent Materials of Insulation Covering>

Next, the crosslinked polymer material that comprises the insulation covering 3 of the insulated wire 1 according to the embodiment of the present disclosure will be described. The crosslinked polymer material composing the insulation covering 3 comprises a silicone resin and a metal ion. The silicone resin comprises a side chain which comprises a substituent group capable of forming an ionic bond with the metal ion. In this crosslinked polymer material, the ionic bond is formed between the substituent group in the side chain of the silicone resin and the metal ion, and the silicone resin is crosslinked by the ionic bond to form a crosslinked product. That is, a polymer chain of the silicone resin is crosslinked via the metal ion. Note that in this specification, the term “metal ion” refers not only to a free metal ion, but also to a metal ion forming an ionic bond with a negatively-charged structure. In addition to the crosslinked product comprising the silicone resin and the metal ion, the present crosslinked polymer material may also comprise additional components such as later-described polar particles as appropriate.

In this embodiment, due to this crosslinked polymer material composing the insulation covering 3 being the silicone resin that is crosslinked to form a three-dimensional network structure, it has excellent properties such as heat resistance and flexibility, similarly to conventional general crosslinked silicone resins. In this crosslinked polymer material, the crosslinked structure is formed via the ionic bond instead of a covalent bond, but the bonding force of the ionic bond is sufficient to improve the heat resistance and mechanical toughness of the crosslinked product, and furthermore provides a high degree of flexibility. Meanwhile, this crosslinked polymer material exhibits high oil resistance, unlike a conventional crosslinked silicone resin, due to the crosslinked structure in the silicone resin being composed of the ionic bond via the metal ion. A conventional general crosslinked silicone resin, in which the polymer chain of a silicone resin is crosslinked with a crosslinking agent made of an organic compound such as an organic peroxide, is highly organic at the crosslinking site, and therefore has a high affinity for oils such as gasoline and oil, which are also organic substances, and upon coming into contact with these substances for a long period of time, oil molecules are likely to be incorporated into the network structure of the crosslinked structure. Meanwhile, in this crosslinked polymer material, the crosslinked location is composed of the ionic bond comprising the metal ion and has strong inorganic properties, and therefore affinity for oils such as oil and gasoline is low, making it difficult for an oil component to be incorporated into the network structure. Accordingly, this crosslinked polymer material exhibits high oil resistance.

In this crosslinked polymer material, from the viewpoint of ensuring sufficient oil resistance, it is preferable that the oil-resistance volumetric expansion coefficient is suppressed to 60% or less, and more preferably 40% or less, and even more preferably 20% or less. Also, it is preferable that the fuel-resistance volumetric expansion coefficient is suppressed to 40% or less, and more preferably 20% or less. Here, the oil-resistance volumetric expansion coefficient and the fuel-resistance volumetric expansion coefficient are evaluated using a liquid resistance test in accordance with JIS K 6258, and for the oil-resistant volume expansion coefficient, the volumetric expansion coefficient of the material is evaluated after the material has been immersed in 150° C. ATF oil (automatic transmission fluid oil) for 72 hours, and for the fuel-resistance volumetric expansion coefficient, the volumetric expansion coefficient of the material is evaluated after the material has been immersed in isooctane for 24 hours. Although there is no particular lower limit for the oil-resistance volumetric expansion coefficient and the fuel-resistance volumetric expansion coefficient, in practically-obtainable crosslinked polymer materials, both are approximately 18 or more.

The physical properties that this crosslinked polymer material preferably has are not particularly specified, and can be set as appropriate according to the application of the insulated wire by selecting the type, content, and the like of the silicone resin, the metal ion, and other additive components to be used. For example, from the perspective of ensuring sufficient mechanical strength as an insulation covering, the crosslinked polymer material preferably has a durometer A hardness of 10 or more, and more preferably 20 or more, and a tensile elastic modulus of 0.1 MPa or more, and more preferably 0.5 MPa or more. Meanwhile, from the viewpoint of ensuring sufficient flexibility as an insulated wire, the crosslinked polymer material preferably has a durometer A hardness of 90 or less, and more preferably 80 or less, and a tensile elastic modulus of 50 MPa or less, and more preferably 15 MPa or less.

Generally, an ionic bond is reversible, and when this crosslinked polymer material with a crosslinked structure formed through an ionic bond is heated to a high temperature, there is a possibility that an ionic bonding point will become delocalized, the crosslinked polymer material will soften or fluidize, and thus the insulation covering 3 will no longer be able to maintain predetermined physical properties or a shape. From the viewpoint of avoiding such a situation and improving the heat resistance of the insulation covering 3, the flow-starting temperature (melting point or fluid point) of the crosslinked product is preferably 150° C. or higher, and more preferably 180° C. or higher. Meanwhile, if there is a desire to take advantage of the softening and fluidization of the crosslinked polymer material, such as when remolding the insulation covering 3, the flow-starting temperature of the crosslinked product need only be set to 300° C. or lower, or even 250° C. or lower.

The insulated wire 1 having the insulation covering 3 according to the present embodiment can be produced by disposing, on the outer periphery of the wire conductor 2, a crosslinkable polymer composition comprising a metal compound serving as a metal ion source and the silicone resin comprising the side chain which comprises the substituent group capable of forming the ionic bond with the metal ion, and then promoting crosslinking of the silicone resin with the metal ion to form the crosslinked product from the crosslinkable polymer composition, thereby producing the insulation covering 3 made of the crosslinked polymer. Here, if a metal compound that releases desired a metal ion by heat, such as a metal complex to be described later, is used as the metal compound, it is possible to easily promote crosslinking and form the insulation covering 3 by heating the crosslinkable polymer composition and causing the metal ion to be released. Also, in this specification, the polymer material after crosslinking is referred to as a crosslinked polymer material and the raw material composition before crosslinking is referred to as a crosslinkable polymer composition to distinguish them.

The crosslinking of the crosslinkable polymer composition by heating may be performed in parallel with the operation of disposing the crosslinkable polymer composition obtained by mixing each component on the outer periphery of the wire conductor 2 through extrusion molding or the like, or may be performed after disposing the crosslinkable polymer composition on the outer periphery of the wire conductor 2 in an uncrosslinked state. From the viewpoint of simplicity of the step of forming the insulation covering 3, it is preferable to promote crosslinking in parallel with the disposition of the crosslinkable polymer composition on the outer periphery of the wire conductor 2. The crosslinking reaction will not proceed unless the metal ion is released by heating, and therefore if the crosslinkable polymer composition comprising the metal compound and the silicone resin is handled without heating, unintended crosslinking can be avoided and the composition can be prepared and stored stably. Each constituent component of the crosslinked polymer material will be described in detail below.

### (1) Silicone Resin

First, the silicone resin that serves as the base resin in this crosslinked polymer material will be described.

In this embodiment, the main material of the crosslinked polymer material composing the insulation covering 3 is a silicone resin comprising a side chain which comprises a substituent group capable of forming an ionic bond with a metal ion. The type of substituent group is not particularly limited as long as it can form an ionic bond with the metal ion included in the crosslinked polymer material. The substituent group is preferably a neutral group in the silicone resin before crosslinking, and a negatively-charged anionic group in the crosslinked product. Particularly preferably, the substituent group is a neutral electron-withdrawing group in the silicone resin before crosslinking, and an anionic group generated by releasing a proton from the electron-withdrawing group in the crosslinked product. An electron-withdrawing group (hereinafter, including those that have become an anionic group) can form a stable ionic bond with the metal ion, and when the silicone resin is crosslinked with the metal ion, the electron-withdrawing group tends to stably form a crosslinked structure and the crosslinked product tends to exhibit high heat resistance and oil resistance.

Preferred examples of an electron-withdrawing substituent group that can form the ionic bond with the metal ion include an acidic group other than a hydroxyl group, such as carboxylic acid group, acid anhydride group, and phosphoric acid group. In particular, the carboxylic acid group and the acid anhydride group can be suitably employed. The number of substituent groups may be one, or two or more, and preferably at least one selected from the group consisting of the substituent groups listed above. Each substituent group listed above is excellent in that they easily form the ionic bond with the metal ion. Also, since each substituent group listed above is the acidic group with relatively low polarity, phase separation is less likely to be caused in the main chain or side chain of the silicone resin, and thus can form a highly uniform crosslinked structure in the structure of the silicone resin. For example, a sulfonic acid group is also the electron-withdrawing substituent group that tends to form the ionic bond with the metal ion, but because of the high polarity, the sulfonic acid group tends to cause phase separation, and thus cannot be suitably employed as the substituent group included in the silicone resin to the same extent as each substituent group listed as preferable above.

As described above, in the silicone resin, due to the substituent group that form the ionic bond with the metal ion being included in the side chain instead of the main chain of the polymer, when the crosslinked structure is formed, a crosslinked structure with strong inorganic properties can be stably formed by suppressing the influence of the main chain, and high oil resistance can be easily obtained in the crosslinked polymer material. Also, by forming the crosslinked structure in the side chain, a crosslinked location maintains a high degree of freedom of movement, and the crosslinked product becomes a material with excellent flexibility. The type and length of the side chain are not particularly limited, but from the viewpoint of enhancing their effects, the silicone resin is preferably one in which the substituent group is introduced into an organic side chain. That is, is it preferable to use organopolysiloxane that comprises the side chain which comprises the substituent group capable of forming the ionic bond with the metal ion. Particularly preferably, the substituent group is bonded to the main chain via an alkyl group or an alkylene group having one or more carbon atoms. Alternatively, the substituent group may be bonded to the main chain via a heteroatom such as an oxygen atom. The substituent group may be introduced at the end of the side chain or at an intermediate part, but from the viewpoint of effectively increasing the stability and degree of freedom of movement of the crosslinked location, it is preferable that the substituent group is introduced at the end. The upper limit of the number of carbon atoms in the side chain is not particularly limited, but from the viewpoint of minimizing the influence of the main chain on the crosslinked location, it is preferable that the number of carbons connecting the main chain and the substituent group is 4 or less.

In the silicone resin, a moiety that can form the ionic bond with the metal ion, such as the electron-withdrawing substituent group, may be included in the main chain (including terminal end portions; the same applies below) as well, or not included in the main chain as long as they are included in the side chain. A preferred example of the main chain that does not include this moiety is a polysiloxane chain that includes only an —Si—O-structure. Examples of the main chain comprising this moiety include a block copolymer comprising a unit consisting of the polysiloxane chain and a unit consisting of a polymer comprising a monomer having the electron-withdrawing group, or a structure in which the electron-withdrawing group is included at the end of the polysiloxane chain. However, it is preferable that the main chain does not include the moiety that can form the ionic bond with the metal ion. This is because if such a moiety is included in the main chain, it may prevent the substituent group in the side chain from forming the crosslinked structure through the ionic bond with the metal ion. Even if the main chain comprises the moiety that can form the ionic bond, it is susceptible to large steric hindrances, and therefore it is not likely to effectively contribute to crosslinking through the formation of the ionic bond with the metal ion, and the effect of improving the material properties such as heat resistance while maintaining high oil resistance through crosslinking will be poor. Furthermore, if the moiety that can form the ionic bond with the metal ion can form a resonance structure, as with a carbonyl group, if such a moiety is present in the main chain, the main chain will participate in resonance, and therefore the uniformity of the crosslinked product tends to be low.

It is most preferable to use the polysiloxane chain comprising only an —Si—O-structure as the main chain, and the silicone resin in which the substituent group that can form the ionic bond with the metal ion is further introduced to the side chain of organopolysiloxane, in which an organic group is bonded to such a polysiloxane chain as the side chain, can be most preferably used as the silicone resin. If the main chain is the polysiloxane chain, the main chain has little effect on the formation of the crosslinking point in the side chain, and the high heat resistance and oil resistance brought about by the crosslinking in the side chain significantly appear as the properties of the overall crosslinked product.

In the silicone resin, the content of the substituent group that can form the ionic bond with the metal ion is not particularly limited, but from the viewpoint of ensuring physical properties through crosslinking, the content is preferably 0.05 mass % or more and 10 mass % or less with respect to the total mass of the silicone resin. More preferably, it is 0.1 mass % or more and 5 masse or less. The content of the substituent group in the silicone resin can be determined by comparing the magnitude of a substituent-specific peak in an infrared absorption spectrum with the magnitude of a spectral peak of a material whose content is known.

The silicone resin preferably has the flow-starting temperature (melting point or pour point) of 150° C. or lower. That is, the silicone resin is preferably liquid at 150° C. or lower. Furthermore, it is preferable that the silicone resin is liquid at room temperature. In this case, when the crosslinkable polymer composition comprising the silicone resin and the metal compound serving as the metal ion source is prepared and disposed on the outer periphery of the wire conductor 2 through extrusion molding or the like, mixture of the components, kneading, and molding of the composition can be easily performed without heating to a very high temperature. Also, by mixing the highly-fluid silicone resin with the metal compound serving as the metal ion source in the crosslinkable polymer composition, the metal compound is well dispersed in the silicone resin, and the crosslinked product in which the crosslinking point is highly uniformly distributed can be formed through crosslinking by heating. Note that since the silicone resin has a relatively low flow-starting temperature, when the composition is molded through extrusion molding or the like, a case may occur in which molding cannot be performed smoothly due to the viscosity of the composition being low. In such a case, the viscosity of the composition may be improved by adding polar particles, which will be described later.

### (2) Metal Component

Next, the metal ion that crosslink the silicone resin in this crosslinked polymer material and the metal compound that is included in the crosslinkable polymer composition before crosslinking and serves as the metal ion source will be described.

The metal species of the metal ion used for crosslinking the silicone resin is not particularly limited, but alkaline earth metals, aluminum, zinc, titanium, zirconium, and the like can be suitably used. The metal ion to be used is preferably an ion of at least one selected from the group consisting of these metals. Each metal ion has a valence of two or more, and easily forms a stable crosslinked structure between the polymer chains of the silicone resin by forming the ionic bond with the substituent group of the silicone resin. Furthermore, since each of the metals listed above is a metal that belongs to a hard acid according to the HSAB rule and has a relatively high ionization tendency, each of the metals forms a stable bond with the substituent group of the silicone resin, and thus is suitable as a metal for forming the crosslinked product.

Among the metal species listed above, aluminum and zirconium are particularly suitable as metals for forming the crosslinked product. Thus, the metal ion to be used is preferably at least one selected from the group consisting of aluminum and zirconium. The metal compound such as a metal complex comprising aluminum or zirconium has high stability to a certain extent, and when mixed with the silicone resin as the metal ion source in a composition before crosslinking, the formation of the crosslinked structure does not easily progress, and the composition before crosslinking has high stability during preparation and storage. Meanwhile, if these metal compounds are heated, the metal ion is relatively easily released and forms the crosslinked product with the silicone resin. The release of the metal ion from the metal compound occurs accompanying decomposition or phase transition of the metal compound, but for example, as shown in later examples, a phase transition start temperature (baseline change start temperature measured through differential scanning calorimetry (DSC) (measurement temperature range: 25° C. to 200° C.; measured in air)) of zirconium (IV) acetylacetonate (Zr-AA) is 180° C., which is a high temperature among various acetylacetonate complexes. Meanwhile, aluminum (III) acetylacetonate has a phase transition start temperature of 112° C., which is not very high, but this compound is characterized by a gradual change in heat quantity from the start of phase transition, and a significant change in heat quantity occurs around 170° C. That is, when the temperature reaches a relatively high temperature of around 170° C., phase transition and release of the metal ion associated therewith progress significantly.

Furthermore, if aluminum and zirconium ions are used as the metal ion, the flow-starting temperature of the crosslinked product is higher than when, for example, titanium is used, and the crosslinked polymer material has excellent heat resistance. This is because aluminum and zirconium are not easily oxidized like titanium, and therefore the existence of an oxidation pathway is unlikely to reduce the efficiency of forming and maintaining the crosslinked structure. Furthermore, when aluminum and zirconium are used, unlike titanium, which is significantly stabilized by oxidation, the ionic bonding point related to crosslinking is increased, resulting in higher polarity in the crosslinked product and higher oil resistance than when using titanium. Also, compared to alkaline earth metals such as calcium, aluminum and zirconium do not have as high an acid hardness as alkaline earth metals, and therefore aluminum and zirconium tend to be dispersed in silicone resin with high uniformity. Furthermore, compared to zinc, aluminum and zirconium tend to have a higher decomposition temperature for the metal compound such as the metal complex, thereby increasing the stability of the composition during preparation and storage.

Also, in the insulated wire 1, if the metal species included in the crosslinked polymer material composing the insulation covering 3 is the same as the metal species that is the main component of the wire conductor 2, at the interface between the wire conductor 2 and the insulation covering 3, it is easier to minimize the influence caused by the presence of the wire conductor 2 on the formation and stable maintenance of the crosslinked structure in the insulation covering 3. For example, if the wire conductor 2 is made of aluminum or an aluminum alloy, aluminum may be used as the metal ion used for crosslinking the silicone resin in the insulation covering 3.

There is no limitation to the metal species listed as preferred above, including aluminum and zirconium, and any metal species can be applied as long as it can crosslink the silicone resin by forming the ionic bond with the substituent group included in the side chain of the silicone resin. Also, the metal ion used for crosslinking the silicone resin is not limited to a monoatomic metal ion, but may also be a polyatomic ion (metal-comprising ion) formed by bonding a metal atom with another atom. However, from the viewpoint of forming a stable ionic bond with the substituent group in the side chain of the silicone resin, the monoatomic metal ion is preferable. The polyatomic ion comprising an organic moiety is not preferable from the viewpoint of improving the oil resistance of the crosslinked product.

The metal ion that crosslink the silicone resin may be introduced into the crosslinked polymer material in any form and from any source, but the metal ion is preferably included in the crosslinkable polymer composition before crosslinking, in the form of a metal compound in which the metal ion is released by heat, as the metal ion source. Here, “by heat” assumes heating, and assumes heating to a temperature higher than normal temperature. The metal ion being released means that the metal ion is released from the metal compound due to decomposition or phase transition of the metal compound.

The metal compound serving as the metal ion source is preferably one that releases the metal ion when heated at 50° C. or higher. That is, it is preferable that the metal compound has a decomposition point or a phase transition point at 50° C. or higher. In this case, during the preparation of the crosslinkable polymer composition or before using the crosslinkable polymer composition (before crosslinking), the release of the metal ion from the metal compound is suppressed, and the progression of crosslinking of the silicone resin is suppressed, whereby the crosslinkable polymer composition has excellent storage stability. That is, when preparing the crosslinkable polymer composition by mixing the metal compound and the silicone resin at a low temperature such as less than 50° C., when storing the prepared crosslinkable polymer composition, or when disposing the crosslinkable polymer composition on the outer periphery of the wire conductor 2 through extrusion molding or the like, the quality of the crosslinkable polymer composition is not likely to deteriorate due to unintentional release of the metal ion from the metal compound and associated crosslinking of the silicone resin. If the metal compound has a decomposition point or phase transition point at 60° C. or higher, or more preferably 70° C. or higher, the effect of improving storage stability will be even higher.

Meanwhile, the metal compound is preferably one that releases the metal ion when heated at 300° C. or lower. That is, it is preferable that the metal compound has a decomposition point or phase transition point at 300° C. or lower. This makes it less likely that the silicone resin will deteriorate at a temperature lower than that at which the metal ion is released from the metal compound, and makes it easier to crosslink the undeteriorated silicone resin with the metal ion. Also, the metal ion is released by heating at an appropriate temperature, whereby the crosslinkable polymer composition has an excellent crosslinking rate. From these viewpoints, it is more preferable that the metal compound has a decomposition point or phase transition point at 250° C. or lower, more preferably at 150° C. or lower, or even more preferably at 120° C. or lower. Note that the decomposition point or phase transition point of the metal compound is expressed as the baseline change start temperature measured through differential scanning calorimetry (DSC) (measurement temperature range: 25° C. to 200° C.; measured in air). Note that the above phase transition point does not include the melting point, and the above phase transition does not include melting. Also, if the metal compound has both the phase transition and decomposition points, or if it has multiple phase transition points, the lower of them (lowest one) is treated as the “decomposition point or phase transition point”.

The metal compound serving as the metal ion source may be of any chemical species as long as it releases the metal ion by heat, but examples of preferred chemical species comprise the metal complex. The metal complex comprises a central metal ion bound to a ligand having an unshared electron pair. When using the metal complex, the effect of stabilizing the metal ion by the ligand is excellent, the release of the metal ion can be suppressed during the preparation of the crosslinkable polymer composition or before the use of the crosslinkable polymer composition, and when crosslinking the silicone resin, the metal ion is likely to be released by heat.

Examples of ligands included in the metal complex include a monodentate ligand that has one coordination site and a polydentate ligand that has two or more coordination sites. The metal complex formed by the polydentate ligand is more stable than metal complexes formed by the monodentate ligand due to the chelation effect. Also, the ligand include a non-bridging ligand in which one ligand coordinates to one metal ion, and a bridging ligand in which one ligand coordinates to two or more metal ions. The bridging ligand may be composed of the monodentate ligand or the polydentate ligand.

The metal compound serving as the metal ion source is preferably the metal complex comprising the polydentate ligand or the bridging ligand. This is because coordination using the polydentate or bridging ligand has a more excellent effect of stabilizing the metal ion by the ligand than non-crosslinking coordination using the monodentate ligand, and therefore the release of the metal ion can be further suppressed during preparation of the crosslinkable polymer composition or before use of the crosslinkable polymer composition.

Among various metal complexes, it is preferable to use the metal complex comprising a β-diketonato ligand (1,3-diketonato ligand) or alkoxide ligand as the metal ion source. This is because the β-diketonato and alkoxide ligands are more likely to form polydentate or bridging coordinations, and have a more excellent effect of stabilizing the metal ion by the ligand than the non-bridging coordination using the monodentate ligand, and thus the release of the metal ion can be effectively suppressed during the preparation of the crosslinkable polymer composition or before use of the crosslinkable polymer composition. In particular, the metal complex comprising the β-diketonato ligand can be suitably used.

The β-diketonato ligand is represented by the following General Formula (1).

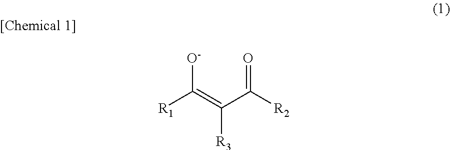

In Formula (1), R₁ and R₂ each independently represent a hydrocarbon group, and R₃ represents a hydrogen atom or a hydrocarbon group. This is also applicable to a case where at least two of R₁, R₂, and R₃ are interconnected by a ring structure. Also, the ligand may have the structure of Formula (1), depending on the resonance structure.

In Formula (1), R₁, R₂, and R₃ may be an aliphatic hydrocarbon group or a hydrocarbon group comprising an aromatic ring. Also, R₁, R₂, and R₃ may include a heteroatom such as an oxygen atom. Examples of the hydrocarbon group included in R₁, R₂, and R₃ include alkyl group, alkoxy group, aromatic group, and fused aromatic group. The number of carbon atoms of R₁, R₂, and R₃ is not particularly limited, but is preferably 1 or more and 8 or less.

Examples of specific β-diketonato ligand include acetylacetonato ligand (acac), 2,2,6,6-tetramethyl-3,5-heptanedionato ligand (dpm), 3-methyl-2,4-pentadionato ligand, 3-ethyl-2,4-pentadionato ligand, 3,5-heptanedionato ligand, 2,6-dimethyl-3,5-heptanedionato ligand, and 1,3-diphenyl-1,3-propanedionato ligand. Among these, from the viewpoint of structural simplicity and the like, the acetylacetonato ligand in which R₁ and R₂ are a methyl group and R₃ is a hydrogen atom in the above Formula (1) is particularly preferable.

The alkoxide ligand is represented by the following General Formula (2).

[Chemical 1]

R₄—O⁻ (2)

In Formula (2), R₄ represents the hydrocarbon group. R₄ may be the aliphatic hydrocarbon group or the hydrocarbon group comprising the aromatic ring. R₄ is preferably the hydrocarbon group having 1 to 10 carbon atoms. Specific examples of the alkoxide ligand include methoxide ligand, ethoxide ligand, isopropoxide ligand, n-propoxide ligand, and n-butoxide ligand.

The content of the metal component that can participate in crosslinking of the silicone resin is the content of the metal ion in the crosslinked polymer material after crosslinking, based on 100 parts by mass of the silicone resin, and is preferably 0.03 parts by mass or more, and more preferably 0.1 parts by mass or more. Also, the content of the metal compound in the crosslinkable polymer composition before crosslinking is preferably 0.1 parts by mass or more, and more preferably 1.0 part by mass or more. In this case, by comprising a sufficiently large amount of the metal ion relative to the silicone resin, the crosslinked product has a high crosslinking density, and exhibits a high effect of improving heat resistance and oil resistance. Meanwhile, the content of the metal component is the content of the metal ion in the crosslinked polymer material after crosslinking, and is preferably 10 parts by mass or less, and more preferably 5 parts by mass or less. Also, the content of the metal compound in the crosslinkable polymer composition before crosslinking is preferably 20 parts by mass or less, and more preferably 10 parts by mass or less. This makes it easier to avoid the effects of comprising a large amount of metal components, such as separation and precipitation of the metal components before crosslinking, and embrittlement and decrease in flexibility of the insulation covering 3 after crosslinking.

### (3) Polar Particles

The crosslinked polymer material composing the insulation covering 3 in the insulated wire 1 preferably comprises polar particles in addition to the crosslinked product obtained by crosslinking the silicone resin with the metal ion in cases where the silicone resin before crosslinking, which is used as a raw material, is of low viscosity, for example. The polar particles serve as a molding aid in the crosslinkable polymer composition before crosslinking, and exhibit a viscosity-increasing effect and a thixotropy-imparting effect. If the silicone resin is in a low-viscosity liquid state, it is difficult to stably dispose the crosslinkable polymer composition on the outer periphery of the wire conductor 2, and even if molding is performed through extrusion molding or the like while promoting crosslinking via the metal ion by heat, problems arise such as insufficient torque applied to molding equipment such as screws and outflow of the composition from the equipment, particularly in the early stage of the crosslinking reaction, making it difficult to proceed smoothly with molding. In view of this, stable molding can be performed by adding the polar particles as a molding aid to increase the viscosity of the composition. Furthermore, since the particles to be added are polarized, the particles do not substantially exhibit oil absorbing properties, and are not likely to impair the oil resistance of the crosslinked silicone resin.

The type of the polar particles is not particularly limited, and the entire particle may be made of a polar material, or the particle of a non-polar material may be surface-treated with a polar material. Specific examples of the polar particles include particles made of silica, metal oxides such as aluminum oxide and zinc oxide, clay minerals such as montmorillonite and sepiolite, cellulose, fluorine resins such as Teflon (registered trademark), and carbon. Among these, one type of particles may be used, or two or more types of particles may be used. Particularly preferably, fumed silica particles are used as the polar particles. This is because it is easy to obtain particles with excellent particle size uniformity with fumed silica, and fumed silica also has a high viscosity-increasing effect and a thixotropy-imparting effect due to the effect of hydrogen crosslinking of a surface silanol group.

Although the particle size of the polar particles is not particularly specified, having a smaller particle size increases the specific surface area, as well as the uniformity of the entire composition, and thus the viscosity-increasing effect and the thixotropy-imparting effect are exhibited more. From this viewpoint, the average particle size of the polar particles is preferably 100 nm or smaller, and more preferably 50 nm or smaller. Meanwhile, if the particle size is too small, higher-order aggregates will be formed and the apparent particle size distribution will become uneven, and therefore the average particle size of the polar particles is preferably 5 nm or larger, and more preferably 7 nm or larger. Also, the particle shape of the polar particles is not particularly limited, but a spherical shape can be suitably exemplified.

The content of the polar particles is preferably 1 part by mass or more, and more preferably 10 parts by mass or more with respect to 100 parts by mass of the silicone resin. In this case, the viscosity-increasing effect and the thixotropy-imparting effect resulting from the addition of the polar particles improve. Meanwhile, the content of the polar particles is preferably suppressed to 100 parts by mass or less, and more preferably 60 parts by mass or less with respect to 100 parts by mass of the silicone resin. This facilitates good dispersion of the polar particles in the silicone resin.

### (4) Other Components

The crosslinked polymer material composing the insulation covering 3 may also comprise additives such as flame retardant, copper damage inhibitor, antioxidant, and colorant as appropriate, in addition to the above-described crosslinked product obtained by crosslinking the silicone resin with the metal ion and optionally-added polar particles, in a range in which the function of the material is not hindered. Also, as a polymer component, a polymer other than the crosslinked product obtained by crosslinking the silicone resin with the metal ion may be included, but the content thereof is preferably kept lower than the content of the above-described crosslinked product. More preferably, the crosslinked polymer material preferably comprises only the above-described crosslinked product as a polymer component, excluding components that are unavoidable, such as components that have not undergone crosslinking in the above-described silicone resin including the substituent group.

Examples of the polymer component that are preferably not included in the crosslinked polymer material include a silicone resin that is crosslinked with a crosslinked structure other than crosslinking performed via the metal ion, except for an unavoidable component. That is, examples include components obtained by crosslinking the silicone resin that comprises the side chain which comprises the substituent group capable of forming the ionic bond with the metal ion, or another silicone resin, without via the ionic bond between the substituent group and the metal ion. Examples of crosslinked structures other than crosslinking performed via the metal ion include an crosslinked structure using an organic crosslinking agent such as organic peroxide, epoxy compound, and amine compound. When the crosslinked structure obtained via the organic crosslinking agent is included in the crosslinked polymer material, it leads to a decrease in oil resistance. Also, regardless of the presence or absence of crosslinking, it is preferable not to be included in the crosslinked polymer material, a silicone resin other than the silicone resin comprising the side chain which comprises the substituent group capable of forming the ionic bond with the metal ion. Furthermore, although there are silicone rubber and other resin materials that can function as molding aids, it is preferable not to be included since these organic molding aids may reduce the oil resistance of the crosslinked polymer material. Also, it is preferable not to be included, a polymer component having a higher flow-starting temperature in an uncrosslinked state than the silicone resin comprising the side chain which comprises the substituent group capable of forming the ionic bond with the metal ion.

Other than polymer components, examples of components that are preferably not included in the crosslinked polymer material include fillers for improving oil resistance. Although this does not preclude the inclusion of fillers such as flame retardants in the crosslinked polymer material, it is not necessary to include fillers whose main purpose is to improve oil resistance. Since the crosslinked product obtained by crosslinking the silicone resin via the metal ion exhibits high oil resistance, there is no need to add such a filler to improve oil resistance. Furthermore, examples of additives that are preferably not included in the crosslinkable polymer composition before crosslinking include (a) photo radical generators and thermal radical generators, and (b) chlorine compounds and bromine compounds. If a compound of group (a) is included in the crosslinkable polymer composition, unintended chemical reactions such as crosslinking of the silicone resin caused by a reaction other than the crosslinking reaction via the metal ion released from the metal compound may occur during heating. In this case, it may become impossible to obtain the crosslinked polymer material that can sufficiently exhibit properties such as heat resistance and oil resistance. Also, if a compound of group (b) is included in a crosslinkable polymer composition, heating may cause coloration or generation of corrosive gas.

### EXAMPLES

Examples are shown below. The present invention is not limited by the examples. Hereinafter, unless otherwise specified, samples were produced and evaluated at room temperature in the air.

### [1] Properties of Crosslinked Silicone Resin

First, the relationship between the composition and the properties of the crosslinked silicone resin was investigated.

### <Preparation of Samples>

### (1) Preparation of Silicone Resin

The following four types of silicone resins were prepared. All four types of silicone resins are liquid at room temperature.

### Modified Silicone A

10 g (2.86 mmol of an epoxy group) of epoxy-modified silicone (“KF-1001” manufactured by Shin-Etsu Silicone Co., Ltd.; epoxy equivalent: 3500 g/mol) was dissolved in 500 mL of diethyl ether, and 0.4 g (2.92 mmol) of 4-aminobenzoic acid (manufactured by Tokyo Kasei Co., Ltd.) was added little by little while stirring vigorously at no more than 30° C. Furthermore, stirring at no more than 30° C. was continued for 3 hours. Thereafter, insoluble matter was removed through filtration, and diethyl ether in the filtrate was distilled off using an evaporator at a bath temperature of no more than 40° C. to obtain a slightly yellow clear oily substance. This product is a carboxylic acid-modified silicone resin in which the epoxy group in the silicone has been converted to benzoic acid (carboxylic acid group equivalent: 3500 g/mol). This was called modified silicone A.

### Modified Silicone B

10 g (2.86 mmol of the epoxy group) of epoxy-modified silicone (“KF-1001” manufactured by Shin-Etsu Silicone Co., Ltd.; epoxy equivalent: 3500 g/mol) was dissolved in 500 mL of diethyl ether, and 0.55 g (3.04 mmol) of 5-aminoisophthal acid (manufactured by Tokyo Kasei Co., Ltd.) was added little by little while stirring vigorously at no more than 30° C. Furthermore, stirring at no more than 30° C. was continued for 48 hours. Thereafter, insoluble matter was removed through filtration, and diethyl ether in the filtrate was distilled off using the evaporator at a bath temperature of no more than 40° C. to obtain a slightly yellow clear oily substance. This product is a carboxylic acid-modified silicone resin in which the epoxy group in silicone has been converted to isophthalic acid (carboxylic acid group equivalent: 1750 g/mol). This was called modified silicone B.

### Modified Silicone C

A slightly yellow clear oily substance was obtained by carrying out the same synthesis method as that of modified silicone B, except that in the above-described synthesis method for modified silicone B, 0.8 g (3.21 mmol) of 4-amino-1-hydroxybutane-1,1-diphosphonic acid (manufactured by Tokyo Kasei Co., Ltd.) was used instead of 0.55 g of 5-aminoisophthalic acid. This product is a phosphoric acid-modified silicone resin in which the epoxy group in the silicone has been converted to a diphosphonic group (phosphoric acid group equivalent: 1750 g/mol). This was called modified silicone C.

### Unmodified Silicone

Unmodified silicone (“KF-96-30,000cs” manufactured by Shin-Etsu Chemical Co., Ltd.) was also prepared.

### (2) Production of Samples

The silicone resin prepared above and the various metal compounds or other crosslinking agents shown below were added in the amounts shown in Table 1 (units are parts by weight) into an amount of xylene that was 5 times their total weight, and the mixture was vigorously stirred at 80° C. for 30 minutes to disperse and mix. Thereafter, the mixture was vacuum-dried and press-molded at 250° C. for 10 minutes to produce 2-mm thick sample sheets, which were used as samples A1 to A9 and B2 to B7.

Also, silicone rubber was prepared as sample B1. Specifically, “ELASTOSIL EL 4500” manufactured by Wacker Asahikasei Silicone Co., Ltd. was mixed with a predetermined curing agent, molded into 2-mm thick sample sheets, and then heated and cured under predetermined conditions to obtain silicone rubber.

The materials used as metal compounds or other crosslinking agents in the production of samples A1 to A9 and B2 to B7 are as follows. In the following, the decomposition point or phase transition point obtained through DSC measurement is shown in parentheses along with the material type.

### Metal Compounds

Zn-AA: Zinc (II) acetylacetonate (105° C.)
Al-AA: Aluminum (III) acetylacetonate (112° C.)
Zr-AA: Zirconium (IV) acetylacetonate (180° C.)
Al—IP: Aluminum (III) triisopropoxide (94° C.)
Ti—IP: Titanium (IV) tetraisopropoxide (85° C.)
ZnO: Zinc (II) oxide (none (>300° C.))
Al-st: Aluminum stearate (125° C.)

### Other Crosslinking Agents

Epoxy compound: Hydrogenated bisphenol A diglycidyl ether (epoxy equivalent: 215-245) “Epolite 4000” manufactured by Kyoeisha Chemical
Amine compound (long chain tertiary amine): 1,6-bis(dimethylamino) hexane (manufactured by Tokyo Kasei)

### <Evaluation Method>

### (1) Curing

In the sample preparation step, after press molding, if there was no flow or stringiness in the sample when visually observed, it was considered to be “A”, which is cured. Meanwhile, samples in which flow or stringiness occurred were considered to be “B”, which indicates insufficient curing.

### (2) Oil-Resistance Volumetric Expansion Coefficient

The oil-resistance volumetric expansion coefficient of each sample was evaluated using a liquid resistance test conforming to JIS K 6258. At this time, the volumetric expansion coefficient was measured after immersion in ATF oil (automatic transmission oil) at 150° C. for 72 hours. The higher the oil-resistance volumetric expansion coefficient is, the higher the oil resistance of the material is.

### (3) Fuel-Resistance Volumetric Expansion Coefficient

The fuel-resistance volumetric expansion coefficient of each sample was evaluated using a liquid resistance test conforming to JIS K 6258. At this time, 2,2,4-trimethylpentane (isooctane) was used as the test fuel oil, and the volumetric expansion coefficient was measured after immersion at 40° C. for 24 hours. The higher the fuel-resistance volumetric expansion coefficient is, the higher the oil resistance of the material is.

### (4) Hardness

The hardness of each sample was evaluated based on JIS K6253-3. Hardness was measured as durometer type A hardness. The lower the hardness is, the more flexible the material is.

### (5) Elastic Modulus

A sample sheet of each sample was cut into strips of length 50 mm×width 5 mm×thickness 2 mm, the gripping width was set to 10 mm, and a tensile test was conducted at a speed of 10 mm/min. Then, the elastic modulus (tensile elastic modulus) was determined by converting the strain between the tensile loads of 1 N and 2 N. The lower the elastic modulus is, the more flexible the material is.

### <Evaluation Results>

In Table 1 below, the content (units: parts by mass) of each component is shown in the upper row for samples A1 to A9 and B1 to B7, and the results of each evaluation are shown in the lower row.

TABLE 1

| Sample number | | A1 | A2 | A3 | A4 | A5 | A6 | A7 | A8 | A9 | B1 | B2 | B3 | B4 | B5 | B6 | B7 |
|---|---|---|---|---|---|---|---|---|---|---|---|---|---|---|---|---|---|
| Metal | Zn-AA | 5 | | | | | 5 | 5 | 20 | 0.1 | | 5 | | | | | |
| compound | Al-AA | | 5 | | | | | | | | | | | | | | |
| or other | Zr-AA | | | 5 | | | | | | | | | | | | | |
| crosslinking | Al-IP | | | | 5 | | | | | | | | | | | | |
| agent | Ti-IP | | | | | 5 | | | | | | | | | | | |
| | ZnO | | | | | | | | | | | | | 5 | | | |
| | Al-st | | | | | | | | | | | | | | 5 | | |
| | Epoxy | | | | | | | | | | | | | | | 5 | |
| | compound | | | | | | | | | | | | | | | | |
| | Amine | | | | | | | | | | | | | | | | 5 |
| | compound | | | | | | | | | | | | | | | | |
| Silicone | Modified | 95 | 95 | 95 | 95 | 95 | | | 80 | 99.9 | | | 100 | 95 | 95 | 95 | 95 |
| resin | silicone A | | | | | | | | | | | | | | | | |
| | Modified | | | | | | 95 | | | | | | | | | | |
| | silicone B | | | | | | | | | | | | | | | | |
| | Modified | | | | | | | 95 | | | | | | | | | |
| | silicone C | | | | | | | | | | | | | | | | |
| | Unmodified | | | | | | | | | | | 95 | | | | | |
| | silicone | | | | | | | | | | | | | | | | |
| | Silicone | | | | | | | | | | 100 | | | | | | |
| | rubber | | | | | | | | | | | | | | | | |

| | | | | | | | | | | | | | | | | |
|---|---|---|---|---|---|---|---|---|---|---|---|---|---|---|---|---|
| Curing | A | A | A | A | A | A | A | A | A | A | B | B | B | B | A | Uneven |
| Oil-resistance | 5 | 6 | 7 | 4 | 12 | 4 | 6 | 3 | 14 | 76 | — | — | — | — | 68 | 78 |
| volumetric expansion | | | | | | | | | | | | | | | | |
| coefficient (%) | | | | | | | | | | | | | | | | |
| Fuel-resistance | 6 | 7 | 7 | 6 | 14 | 3 | 4 | 4 | 14 | 51 | — | — | — | — | 50 | 48 |
| volumetric expansion | | | | | | | | | | | | | | | | |
| coefficient (%) | | | | | | | | | | | | | | | | |
| Hardness (type A) | 60 | 51 | 58 | 67 | 56 | 65 | 71 | 77 | 42 | 55 | — | — | — | — | 58 | 62 |
| Elastic modulus | 2.4 | 2.1 | 1.8 | 2.2 | 2.1 | 2.8 | 3.2 | 3.8 | 1.5 | 1.9 | — | — | — | — | 3.1 | 3.8 |
| (MPa) | | | | | | | | | | | | | | | | |

According to Table 1, samples A1 to A9 were all obtained using a modified silicone resin and a metal complex as raw materials. In these samples, the material was sufficiently cured after press molding (“A” in curing evaluation). This corresponds to the fact that a metal ion is released from a metal complex by heating during press molding, and crosslinking progresses due to an ionic bond being formed with a substituent group of the modified silicone resin. In these samples, an oil-resistance volumetric expansion coefficient and an fuel-resistance volumetric expansion coefficient of a crosslinked product were both suppressed to 20% or less, indicating high oil resistance. This is thought to be because the affinity for the oil component is low at a crosslinked location via the metal ion. Furthermore, in each sample, compared to silicone rubber of sample B1, the type A hardness was suppressed to 1.5 times or less and the elastic modulus was suppressed to 2 times or less, indicating that although the samples are inferior to silicone rubber, they have relatively high flexibility. From this, it can be said that even if the crosslinked structure in the silicone resin is formed by ionic bonding via the metal ion, the inherent flexibility of the crosslinked silicone resin is exhibited and oil resistance is achieved.

Next, samples B1 to B7 will be considered. Sample B1 includes silicone rubber in which α silicone polymer chain has been crosslinked with an organic chain. Corresponding to this, the oil-resistance volumetric expansion coefficient and the fuel-resistance volumetric expansion coefficient are both at high levels exceeding 50%, and the oil resistance is low.

In sample B2, the silicone resin used was unmodified and did not include the substituent group that could form the ionic bond with the metal ion. Sample B3 does not include any component that can form the crosslinked structure with the silicone resin. Also, in samples B4 and B5, zinc oxide and aluminum stearate were used as the metal compound, respectively, instead of the metal complex. Each of these compounds does not release the metal ion even when heated. That is, none of the samples B3 to B5 comprise a metal ion source in their materials. In these samples B2 to B5, corresponding to the lack of the substituent group that can form the ionic bond with the metal ion or a lack of the metal ion, a crosslinked product of the silicone resin is not formed and the composition is not sufficiently cured (curing evaluation “B”). Since a sample serving as a cured product was not obtained, no evaluation for various properties could not be made.

In samples B6 and B7, an organic compound was used instead of the metal compound as the crosslinking agent. Corresponding to this, the oil-resistance volumetric expansion coefficient and the fuel-resistance volumetric expansion coefficient are as high as or higher than those of the silicone rubber of sample B1, and the oil resistance is poor. This is because the crosslinked location is highly organic and swells with oil and fuel. In particular, in sample B7, an amine compound, which is a basic molecule, is used as a crosslinking agent, and an carboxylic acid group in the modified silicone are crosslinked due to the basicity of an amino group, but since the crosslinked structure is highly organic compared to the crosslinked structure obtained via the metal ion, swelling due to oil and fuel cannot be suppressed. Also, due to the basicity of the amine compound, when the amine compound is mixed with the silicone resin, gelation immediately progresses, and a uniform cured product cannot be obtained.

Here, samples A1 to A9 will be compared with each other. In samples A1 to A5, the types of metal complexes used are different, but high oil resistance and flexibility are both achieved in all of the samples A1 to A5. Among them, samples A2 and A3, in which β-diketonato complexes of aluminum and zirconium are used, have particularly high oil resistance and flexibility. Meanwhile, sample A5, in which a titanium alkoxide complex is used, has slightly lower oil resistance.

Samples A1, A6, and A7 differ in the type of modified silicone resin used. When these are compared with each other, samples A1 and A6, in which carboxylic acid-modified silicone resin is used, have particularly high flexibility.

Samples A1, A8, and A9 differ in the addition of the metal complex. When these evaluation results are compared with each other, the oil resistance is higher the higher the amount of the metal complex added is, and the flexibility is higher the lower the amount of the metal complex added is. This is interpreted to be because the crosslinking density in the silicone resin increases as the amount of metal complex added increases.

[2] Moldability when Adding Polar Particles

Next, moldability was evaluated for the case where polar particles were added to a composition comprising the silicone resin and the metal compound.

### <Preparation of Samples>

40 parts by mass of fumed silica serving as polar particles (“Aerosil 200” manufactured by Nippon Aerosil Co., Ltd.; average particle size: 12 nm), and 5 parts by mass of A1-AA were added to 95 parts by mass of modified silicone A synthesized in the above-described Test [1], and were mixed and kneaded at room temperature using a mixer and kneader (manufactured by Primix) to prepare a molding raw material.

### <Evaluation Method>

The molding raw material obtained above was charged into the barrel of a Capillograph (manufactured by Toyo Seiki Seisakusho), and the piston was pushed down to extrude the molding raw material through a die with a 1 mm hole. The temperature of the barrel and die was set to 40° C., and other conditions were based on JIS K 7199. Moldability was evaluated by observing the state of the extruded strand.

Furthermore, a portion of the strand obtained above was cut out and left in a thermostatic chamber at 80° C. for 5 hours. Then, the cut-out portion was further left in a thermostatic chamber at 200° C. for 20 minutes to complete the crosslinking reaction. Thereafter, the presence or absence of deformation of the sample was visually evaluated in comparison to the state before being left in the thermostatic chamber. Furthermore, the sample was placed on a hot plate at 190° C., and the presence or absence of melting was visually confirmed.

### <Evaluation Results>

Observation of the strand during the extrusion step revealed that the extruded strand was continuously extruded without sag or breakage. Also, the shape of the extruded strand was sufficiently maintained. This confirms that the molding raw material to which the polar particles were added exhibits high moldability.

Also, according to observation after the crosslinking reaction was completed, it was confirmed that no deformation had occurred compared to before crosslinking performed through being left in the thermostatic chamber. Furthermore, according to visual observation performed when the sample was placed on a hot plate, no melting of the sample occurred. These results confirm that the addition of the polar particles does not hinder the progress of crosslinking of the silicone resin by the metal ion, and does not impair the heat resistance of the crosslinked polymer material obtained through crosslinking.

Although the embodiments of the present disclosure have been described in detail above, the present invention is not limited in any way to the above-described embodiments, and various modifications can be made without departing from the gist of the present invention.

### LIST OF REFERENCE NUMERALS

1 Insulated wire
2 Wire conductor
3 Insulation covering
5 Wire harness
51 Insulated wire
52 Connector
53 Tape

1. An insulated wire comprising:
a wire conductor; and
an insulation covering which comprise a crosslinked polymer material covering an outer periphery of the wire conductor,
wherein the crosslinked polymer material comprising:
a metal ion; and
a silicone resin comprising a side chain which comprises a substituent capable of forming an ionic bond with the metal ion, and
the silicone resin forms a crosslinked product through the ionic bond between the substituent and the metal ion.

2. The insulated wire according to claim 1, wherein the crosslinked polymer material comprises polar particles in addition to the crosslinked product.

3. The insulated wire according to claim 2, wherein the particles contain at least one selected from the group consisting of silica, metal oxide, clay mineral, cellulose, fluororesin, and carbon.

4. The insulated wire according to claim 2, wherein the particles are fumed silica minute particles.

5. The insulated wire according to claim 2, wherein the minute particles have an average particle size of 5 nm or larger and 100 nm or smaller.

6. The insulated wire according to claim 2, wherein the crosslinked polymer material contains 1 part by mass or more and 100 parts by mass or less of the minute particles with respect to 100 parts by mass of the silicone resin.

7. The insulated wire according to claim 1, wherein the silicone resin has a flow starting temperature of 150° C. or lower.

8. The insulated wire according to claim 1, wherein the substituent contained in the silicone resin is an anionic group generated from at least one selected from the group consisting of a carboxylic acid group, an acid anhydride group, and a phosphoric acid group.

9. The insulated wire according to claim 1, wherein the silicone resin comprises a main chain to which the substituent is bonded via an alkyl group or an alkylene group having one or more carbon atoms.

10. The insulated wire according to claim 1, wherein the silicone resin comprises the main chain which does not contain a moiety capable of forming an ionic bond with the metal ion.

11. The insulated wire according to claim 10, wherein the main chain of the silicone resin is an organopolysiloxane chain.

12. The insulated wire according to claim 1, wherein the metal ion can be released by heat as a metal ion capable of forming a metal complex with a β-diketonato ligand or alkoxide ligand.

13. The insulated wire according to claim 12, wherein the metal ion can be released from the metal complex by heating at 50° C. or higher and 300° C. or lower.

14. The insulated wire according to claim 1, wherein the metal ion is an ion of at least one selected from the group consisting of alkaline earth metals, aluminum, zinc, titanium, and zirconium.

15. The insulated wire according to claim 14, wherein the metal ion is an ion of at least one of aluminum and zirconium.

16. The insulated wire according to claim 1, wherein the crosslinked polymer material contains 0.03 parts by mass or more and 10 parts by mass or less of the metal ion with respect to 100 parts by mass of the silicone resin.

17. The insulated wire according to claim 1, wherein the crosslinked polymer material does not comprise a component, except for an unavoidable component, in which the silicone resin is crosslinked without via the ionic bond between the substituent and the metal ion.

18. A wire harness comprising the insulated wire according to claim 1.

19. A production method for insulated wire, by which the insulated wire is produced according to claim 1, comprising:
disposing a crosslinkable polymer composition containing a metal compound from which the metal ion is released by heat and the silicone resin, on an outer periphery of the wire conductor;
producing the insulation covering comprising the crosslinked polymer material by forming the crosslinked product from the crosslinkable polymer composition by heating.
